(19) United States
(12) Patent Application Publication
(10) Pub. No.: US 2007/0294265 A1
(43) Pub. Date: Dec. 20, 2007

(54) Identification of content downloaded from the internet and its source location

(76) Inventors: Anthony Scott Askew, San Francisco, CA (US); David Martinez, Antioch, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/448,273

(22) Filed: Jun. 6, 2006

(51) Int. Cl. G06F 7/00; G06F 17/30; G06F 17/00

(52) U.S. Cl. 707/100; 707/1; 715/501.1; 715/530

(57) ABSTRACT

A method for identifying a predetermined type of content such as video from data retrieved on the Internet to facilitate bookmarking of the content is disclosed. The method comprises determining a source location of data retrieved from the Internet, determining whether the data correspond to the predetermined type of content, and responsive to determining that the data correspond to the predetermined type of content, storing the source location of the data. The method may further comprise retrieving at least a portion of the content through the Internet, and storing at least a part of the retrieved portion of the content as a graphical representation of the content. The method may further comprise displaying said part of the retrieved portion of the content in a user interface for bookmarking the content together with the source location and information describing the content.

### BACKGROUND OF THE INVENTION

1. Field of the Invention

The present invention relates to identifying a particular type of content retrieved from the Internet, and more specifically, identifying the content of interest downloaded from the Internet and its source URL and storing the source URL for bookmarking the content.

2. Description of the Related Art

Internet users often browse the Internet to find content of interest, such as video content, music content, and the like. The users typically use Internet browsers, such as Internet Explorer™ from Microsoft Corporation, running on their computers to find and play such content on the Internet. The users access a particular website that is associated with the content by entering the URL (Uniform Resource Locator) or source location of the website in the Internet browser. Upon accessing the website, users typically find a link or an icon that is associated with the content. Activating the link or icon causes the content to be played in the Internet browser.

Due to various reasons including copyright restrictions and protection of the content from illegal copying, the websites often cause the actual URL or the source location of the content itself hidden from view by the user in the Internet browsers. Thus, it is not possible for a user who viewed or played such content that was of interest to the user to bookmark the actual URL or the source location of the content itself. Rather, the user has to bookmark the URL or the source location of the website that included the icon or link that leads to that played content. This has the disadvantage that it is not possible to directly access the content of interest without first accessing the website and that the website may not necessarily maintain the link or icon leading to the content.

Therefore, there is a need for a convenient way of identifying the actual URL or source location of the content viewed or played while browsing the Internet. There is also a need for a convenient way of bookmarking the content with the identified URL or source location.

### SUMMARY OF THE INVENTION

Embodiments of the present invention include a computer-implemented method for identifying a predetermined type of content from data retrieved on the Internet to facilitate bookmarking of the content. The method comprises determining a source location of data retrieved from the Internet, determining whether the data correspond to the predetermined type of content, and responsive to determining that the data correspond to the predetermined type of content, storing the source location of the data.

The method may further comprise determining whether the data correspond to a predetermined type of page, and responsive to determining that the data correspond to the predetermined type of page, storing the source location of the data. The method may still further comprise retrieving at least a portion of the content through the Internet, and storing at least a part of the retrieved portion of the content as a graphical representation of the content. Furthermore, the method may further comprise displaying said part of the retrieved portion of the content in a user interface for bookmarking the content together with the source location and information describing the content.

In one embodiment, the predetermined type of content is video data. In one embodiment, the source location is determined by determining the URL of the source location of the data retrieved from the Internet based on packet information corresponding to the data.

The present invention has the advantage that the actual source location or URL of the content can be determined and saved automatically while the content is being retrieved from the Internet. Therefore, the actual URL and graphical representations of the retrieved content can be presented later in a user interface by which the retrieved content can be conveniently added to a content bookmark. Since the actual URL is already determined and presented in the user interface together with the graphical representation of the content, a large part of the essential information for bookmarking the content is already readily available for bookmarking in the user interface without the need for any additional access to the content or source location through the Internet.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates the architecture of the system for identifying content and the source locations for content bookmarking, according to one embodiment of the present invention.

FIG. 2 illustrates a method of identifying the content of interest and its actual URLs to facilitate bookmarking of the content with the URL, according to one embodiment of the present invention.

FIG. 3 illustrates a method of bookmarking the content of interest with its actual URL, according to one embodiment of the present invention.

FIG. 4 illustrates the URLs stored in the stack of the browser plug-in application for identifying content of interest and its actual URLs, according to one embodiment of the present invention.

FIG. 5 illustrates a user interface for bookmarking the content of interest with its actual URL, according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

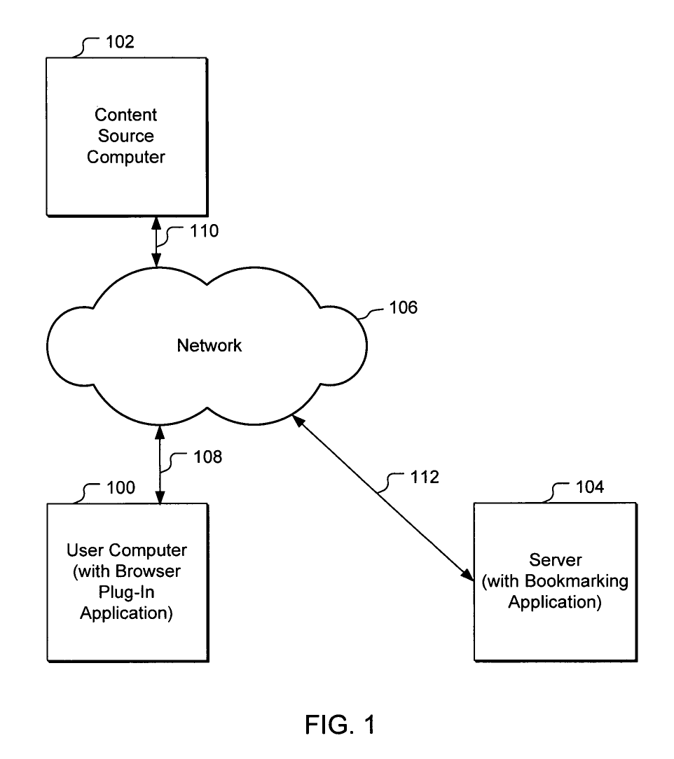

FIG. 1 illustrates the architecture of the system for identifying content and the source locations for content bookmarking, according to one embodiment of the present invention. A user computer 100, a content source computer 102, and a server 104 communicate with one another through a network 106 such as the Internet using conventional network communication protocols such as TCP/IP and HTTP.

The content source computer 102 stores content for viewing in other computers through the network 106. For purposes of illustration herein, the content source computer 102 is described herein as a video server that stores video content and makes the video content available for viewing at other remote computers through the network 106. However, note that the content source computer 102 can store any other type of content such as music for playing at other remote computers through the network 106.

For purposes of illustration, the user computer 100 is described herein as a general purpose computer. However, note that the user computer 100 can be any type of computing device, for example, personal computers, a general personal computer, a personal digital assistant (PDA), a smartphone (including both computing functions and cellular telephone functions), media players (e.g., mp3 music players or video players), a cellular telephone with some computing functionality, etc. The user computer 100 runs an Internet browser such as Internet Explorer™ from Microsoft Corporation, and also includes a plug-in application for the browser. The plug-in application is adapted to run in the background of the Internet browser, and performs the method of identifying the content of interest (here, video content) and the actual URL or source location of the content. The plug-in application also sends the URLs corresponding to the identified video content to the server 104 to facilitate bookmarking of the video content in a video bookmarking application running on the server 104.

More specifically, a user browses the Internet 106 using the Internet browser on the user computer 100 to view video content stored in various locations throughout the network 106. For example, the user may browse the Internet to find video content stored on the content source computer 102. The content source computer 102 provides the video content to the user computer 100 through the network 106 via links 110, 108 so that the video content can be played on the Internet browser on the user computer 100.

The browser plug-in application running in the background of the user computer 100 monitors the actual URLs of the network traffic through the link 108 by analyzing the packets in the network traffic, and identifies video content in the network traffic. In one embodiment, video content can be identified based on the http headers and/or the file extensions (e.g., mpg, avi, .mov, .wmv, and the like) associated with the packets for the content. In another embodiment, video content can be identified by examining the file signatures (also known as “magic numbers”) of a video content. Typically, video content can be identified by a predetermined pattern (file signatures or magic numbers) in a portion of the video content file. For example, the first few binary bytes of the actual video content can have a predetermined pattern and thus be predictable for a specific video file format. Thus, video content can be identified by examining portions of the network traffic and identifying a predetermined file signature (magic number) associated with a particular type of video content or video file. When video content is identified, the browser plug-in application stores the URL corresponding to the identified video content and also provides the stored URL to the server 104 through the network 106 via the links 108, 112.

The server 104 includes a bookmarking application that operates in conjunction with the browser plug-in application. The bookmarking application receives the URLs corresponding to the identified video content sent from the browser plug-in application ion the user computer 100. Using the received URLs, the bookmarking application accesses the video content corresponding to the received URLs and obtains snapshots (for example, still images) of parts of the video content. The bookmarking application also assigns identifications to the video snapshots together with the URLs and stores the video snaps shots with the URLs. The identifications of the video snapshots and the associated URLs are sent back to the browser plug-in application on the user computer 100 through the network 106 via the links 112, 108.

When the user accesses the bookmarking application on the server 104 from the user computer 100 through the network 106, a predetermined number of the most recent identifications stored in the browser plug-in application are sent back to the server 104 through the network 106. The server 104 causes the video snapshots and the URLs corresponding to those most recent identifications to be displayed in a user interface for creating, editing, or managing bookmarks for video content. The bookmarking application of the server 104 causes such user interface to be displayed on the user computer 100 by providing data to be used in the user interface through the network 106 via the links 112, 108, so that the user can create, edit, delete, or otherwise manage the video bookmarks.

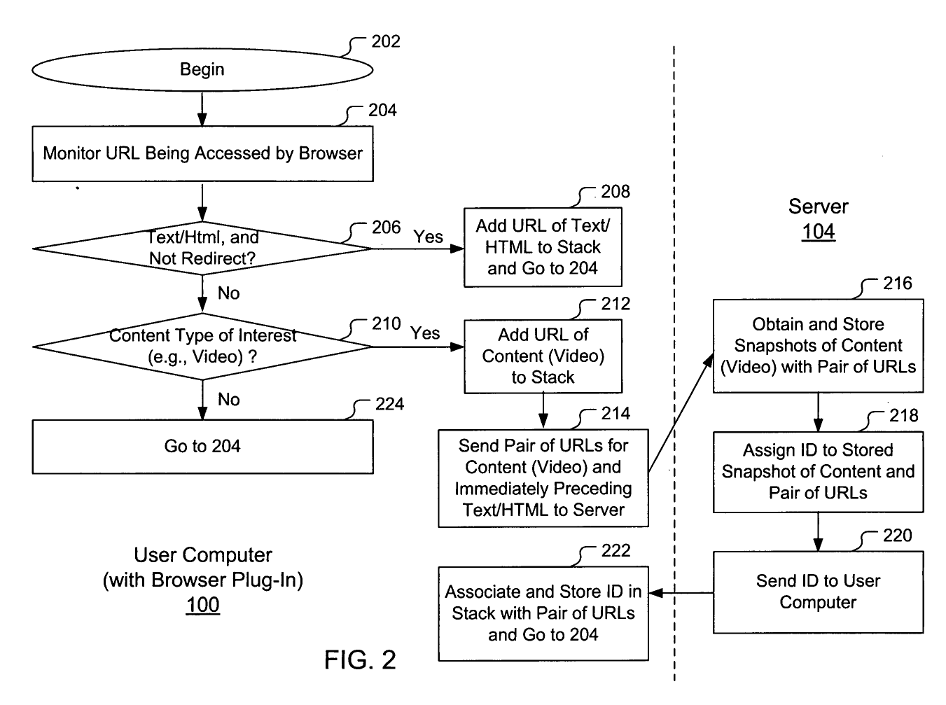

FIG. 2 illustrates a method of identifying the content of interest and its actual URLs to facilitate bookmarking of the content with the URLs, according to one embodiment of the present invention. As the process begins 202, the browser plug-in application running on the user computer 100 monitors the URL being accessed by the Internet browser while the user accesses various websites on the Internet 106. The URLs can be monitored by analyzing the packet data in the network traffic and identifying the URLs in the packet data. Since the network traffic typically complies with TCP/IP and HTTP protocols, the URLs would consist of a header beginning with “http:H//” that can be used to identify the URLs. Another indicator of the URL would be the http content type in the http headers.

For each webpage accessed by the user computer 100, the browser plug-in application determines 206 whether the webpage is a text or html page and whether the website is a redirect page. Determining whether the webpage is a text or html page can be accomplished by analyzing the http headers of the packets corresponding to the webpage. The http headers are lines of text that are sent before the HTML content is sent. They include, for example, the http status codes, the content type, the content length, the content of the cookies for the browser to store, etc. For instance, an example QuickTime™ video file by Apple Computer, Inc. typically includes the following types of http headers: HTTP/1.1 200 OK; Date: Wed, 15 Nov. 1995 06:25:24 GMT; Last-Modified: Wed, 15 Nov 1995 04:58:08 GMT; Content-Length: 260121; Content-Type: video/quicktime. These headers would appear before immediately before the stream of a QuickTime video. For another example, a redirect page would typically include the following types of headers: HTTP/1.1 301 Moved Permanently; Date: Wed, 15 Nov 1995 06:25:24 GMT; Last-Modified: Wed, 15 Nov 1995 04:58:08 GMT; Content-Type: text/html. For still another example, a regular web page would typically include the following types of headers: HTTP/1.1 200 OK; Date: Wed, 15 Nov 1995 06:25:24 GMT Last-Modified: Wed, 15 Nov 1995 04:58:08 GMT; Content-Type: text/html. Also a webpage can be determined to be a redirect page if the HTTP status codes of the packets corresponding to the webpage are, for example, 301, 302, 303, or 304. If the accessed webpage is a text or html page and is not a redirect page, the URL of that webpage, as determined by the browser plug-in application in step 204, is added 208 to a stack maintained by the browser plug-in application and the process goes to step 204 to continue to monitor the URLs of subsequent webpages accessed by the user computer 100.

If the accessed webpage is not a text or html page or is a redirect page, then the browser plug-in application determines 210 whether the accessed webpage is the content type of interest (here, video content). If the accessed webpage is video content, the URL of the video, as determined by the browser plug-in application in step 204, is added 212 to the stack. Then, the browser plug-in application sends 214 a pair of the URLs corresponding to the video content and the immediately preceding text or html page to the server 104. Note that the browser plug-in application and the user's identification or log-in ID with the server 104 may be associated with each other, and the log-in ID may be sent to the server 104 together with the pair of the URLs to store the URLs in the server 104 properly associated with the user's log-in ID.

Sending the URL corresponding to the immediately preceding text or html page in addition to the URL corresponding to the video content is beneficial, because in some instances the video bookmarking application in the server 104 is not able to bookmark the URL to the actual video content due to copyright restrictions. In one embodiment, the bookmarking application in the server 104 classifies the URL of the video content to “whitelisted domains,” “blacklisted domains,” and “graylisted domains.” Whitelisted domains are URLs known to the bookmarking application to have no copyright restriction, in which case the URL of the actual video content can be used to bookmark the video content. Blacklisted domains are URLs known to the bookmarking application to have copyright restrictions, in which case the URL of the actual video content cannot be used to bookmark the video content. For blacklisted domains, the URL of the immediately preceding text or html webpage is used to bookmark the video content and thus the video content will have to be accessed through that text or html page rather than being directly accessed. Graylisted domains are URLs unknown to the bookmarking application to be either a whitelisted domain or a blacklisted domain. Users of the bookmarking application can designate the graylisted domain as either a whitelisted domain or a blacklisted domain, which designation can also be corrected by the bookmarking application if it turns out to have been incorrectly designated.

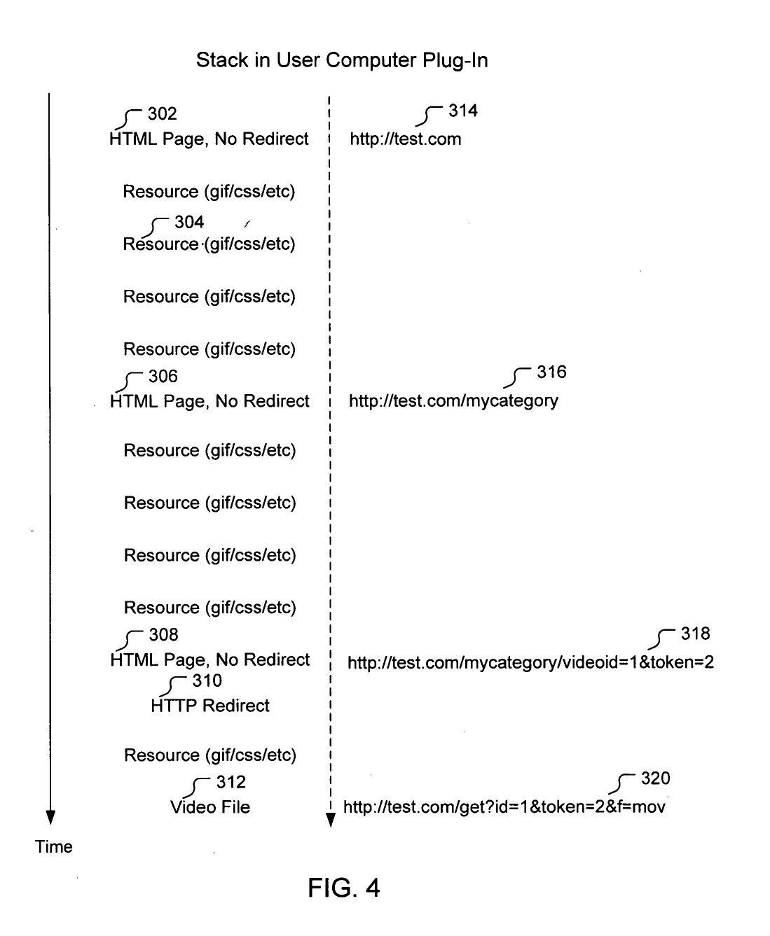

Since the URLs of the text/html pages and video content are added to the stack in steps 208 and 212, the stack typically includes the URLs corresponding to a series of text or html pages with some URLs corresponding to video content. This is shown in FIG. 4, which illustrates the URLs stored in the stack of the browser plug-in application, according to one embodiment of the present invention.

Referring to FIG. 4, the URLs 314, 316, 318, and 320 were received in chronological order. The URL 314 (http://test.com) is the URL for the HTML page 302 which is not a redirect page. Because it is an HTML page and not a redirect page, its URL 314 is stored in the stack (see steps 206, 208). However, because the HTML page 302 is not a video page, the process in FIG. 2 goes back to step 204 to monitor subsequent URLs for subsequently accessed pages. The Resource pages, such as Resource (gig/css/etc) 304, are not HTML or text pages and thus their URLs are not stored in the stack as shown in FIG. 4. The URL 316 (http://test.com/mycategory) is the URL for the HTML page 306 which is also not a redirect page, and is also stored in the stack (see steps 206, 208). The URL 318 (http://test.com/mycategory/videoid=1&token=2) is the URL for the HTML page 308 which is not a redirect page, and is also stored in the stack (see steps 206, 208). The next page 310 is an HTTP Redirect page and thus its URL is not saved in the stack (see steps 206, 208). The URL 320 (http://test.com/get?id=1&token=2&f=mov) is the URL for the video content 312, and thus its URL 320 is stored in the stack (see steps 210, 212). Once the URL 320 of the video content 312 is saved, the browser plug-in application sends the pair of the URLs 320, 318 of the video content 312 and the immediately preceding text/html page (here, the HTML page 308), respectively, to the server 104 for further processing (see step 214).

Referring back to FIG. 2, once the pair of URLs is sent 214 to the server 104, the server 104 obtains and stores 216 snapshots of the video content with the pair of URLs. In this regard, the server 104 access the video content using the URL corresponding to the video, and causes a portion (e.g., 5-10%) of the video content to be played on a video player application running on the server 104. The server 104 stores 216 each of the frames of the played video in the form of image files as the snapshots (graphical representations) for the video content. In one embodiment, the frame with the largest file size (measured in bytes) is selected and stored 216 as the representative snapshot for the video content. Note that the snapshots of the video content are obtained and stored only for whitelisted URLs or for graylisted URLs that are designated by the user to be whitelisted URLs. For blacklisted URLs, the snapshots are not obtained or stored with the pair of URLs. Also note that step 216 may be omitted if the snapshot corresponding to the URL corresponding to the video was previously obtained and thus is already stored in the server 104.

The server 104 also assigns 218 an ID (identification) to the stored snapshot of the video content and the pair of URLs, and sends 220 the assigned ID to the browser plug-in application of the user computer 104. The browser plug-in application associates and stores 222 the ID in the stack with the pair of the URLs, and the process returns to step 204 to monitor the URLs for subsequent data accessed by the browser.

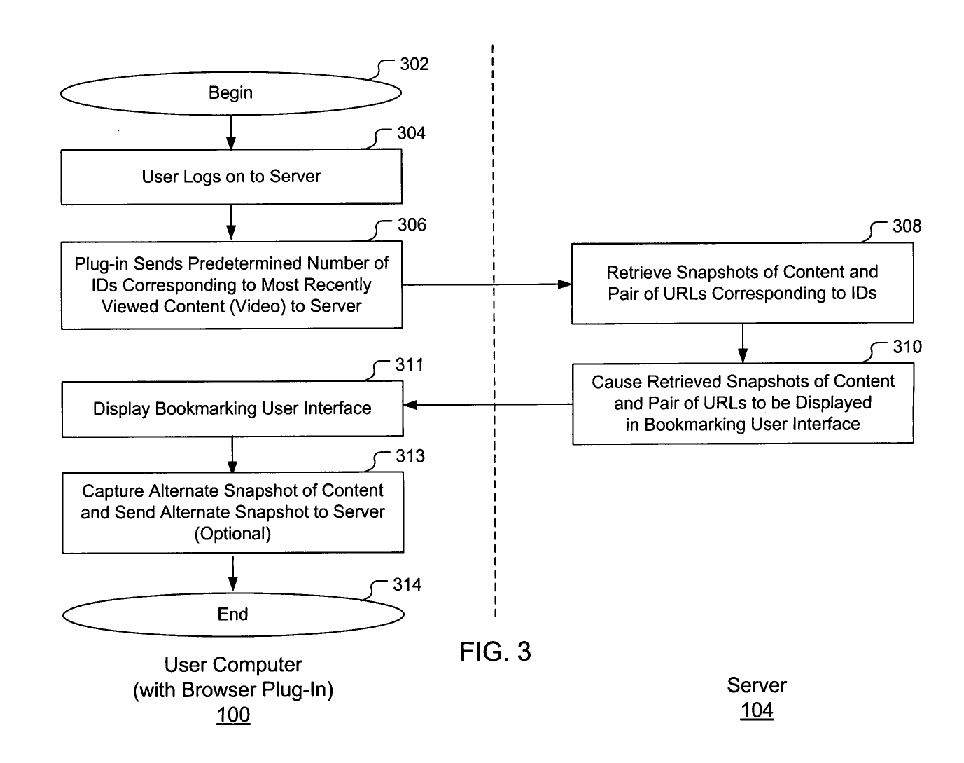

FIG. 3 illustrates a method of bookmarking the content of interest with its actual URL, according to one embodiment of the present invention. The method of FIG. 3 is performed when the user accesses the server 104 from the user computer 100 through the network 106. As the process begins 302, the user logs on 304 to the server 104 using. the log-in ID. This causes the browser plug-in application on the user computer 100 to send 306, to the server 104 through the network 106, a predetermined number (e.g., 9) of IDs corresponding to the most recently viewed video content as stored in the stack of the browser plug-in application. The server 104, upon receipt of the IDs, retrieves 308 the snapshots of the video and the pairs of URLs corresponding to the IDs. The server 104 causes 310 the retrieved snapshots (if available) together with the URL of the video or the URL of the immediately preceding page to be displayed in a user interface for the user to create, add, delete, or otherwise edit video bookmarks for the user. The server 104 causes 310 the user interface to be displayed on the user computer 100 by providing the data to be displayed in the user interface to the user computer 100 through the network 106 via links 112, 108. The bookmarking user interface is displayed 311 on the user computer 100 using the data received from the server 104. Optionally, the user has the option of causing the browser plug-in application to capture 313 an alternate snapshot of a particular video content displayed on the bookmarking user interface and send 313 the alternate snapshot to the server 104, in which case the server 104 would replace the previously captured snapshot for that particular video content with the alternate snapshot. Then, the process ends 314.

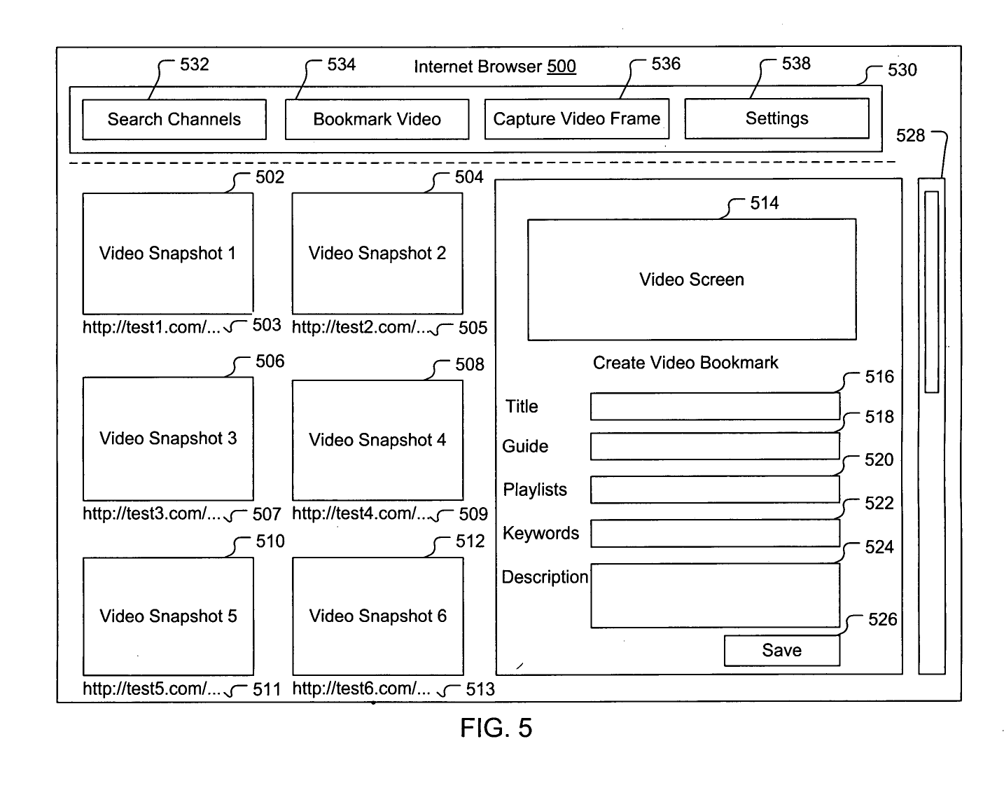

FIG. 5 illustrates an example of a user interface for bookmarking the content of interest with its actual URL, according to one embodiment of the present invention. The user interface is displayed, for example, in an Internet browser 500 running on the user computer 100 with data provided by the server 104 through the network 106. The user interface includes the video snapshots 502, 504, 506, 508, 510, 512 with their corresponding URLs 503, 505, 507, 509, 511, 513, respectively. The number of video snapshots 502, 504, 506, 508, 510, 512 is identical to the predetermined number of IDs sent by the browser plug-in application on the user computer 100 to the server 104, as illustrated in step 306 of FIG. 3. Therefore, additional video snapshots may exist on the user interface depending upon the number of IDs, and may be viewed by scrolling down using the scroll bar 528. Upon clicking one of the video snapshots 502, 504, 506, 508, 510, 512, the actual video accessed through the corresponding URLs 503, 505, 507, 509, 511, or 513 can be displayed in the video screen 514 so that the user can preview the video before creating a bookmark for that video. Various data (e.g., title 516, guide 518, playlists 520, keywords 522, description 524, or other data) can be entered for the selected video bookmark, and the video bookmark can be saved by clicking the save icon 526.

The user interface also shows the toolbar 530 that is displayed by the browser plug-in application running on the user computer 100. The toolbar 530 includes icons such as a search channels icon 532, a bookmark video icon 534, a capture video frame icon 536, and a settings icon 538. When the capture video frame icon 536 is activated while, for example, the video corresponding to video snapshot 502 is played in the video screen 514, the browser plug-in application causes the user computer 100 to capture a video frame of the video displayed on the video screen 514, and send the captured video frame to the server 104 (see step 313 in FIG. 3). The server 104 then replaces the video snapshot 502 with the captured video frame.

The present invention has the advantage that the actual source location or URL of the content can be determined and saved automatically based on the packet data of the content while the content is being retrieved from the Internet. Therefore, the actual URL and graphical representations of the retrieved content can be presented later on in a user interface through which the retrieved content can be conveniently added to a content bookmark. Since the actual URL is already determined and presented in the user interface together with the graphical representation of the content, a large part of the essential information for bookmarking the content is already readily available for bookmarking in the user interface without the need for any additional access to the content or source location through the Internet.

The methods of the present invention as described variously in FIGS. 1-5 can be implemented in the form of computer software or a computer program product including computer instructions adapted to perform such methods. Such computer software or computer program product may be stored in any type of computer readable medium, and such computer instructions may be executed by a processor of a computer. The computer may be any type of computer, including personal computers, general purpose computer, servers, personal digital assistants, smartphones (including both computing functions and cellular telephone functions), media players (e.g., mp3 music players or video players), cellular telephones with some computing functionality, etc. Therefore, the present invention is not limited to the type of hardware in which the methods are performed.

Upon reading this disclosure, those of ordinary skill in the art will appreciate still additional alternative structural and functional designs for a system and a process for identifying content of interest in data retrieved in a network and facilitating convenient bookmarking for the identified content through the disclosed principles of the present invention. For example, although the embodiments of the present invention have been described such that the browser plug-in application runs on a user computer and the bookmarking application runs on a separate server, both the browser plug-in application and the bookmarking application may run on a single computer or can be parts of the same software.

Thus, while particular embodiments and applications of the present invention have been illustrated and described, it is to be understood that the invention is not limited to the precise construction and components disclosed herein. Various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A computer-implemented method of identifying a predetermined type of content, the method comprising:
determining a source location of data retrieved from the Internet;
determining whether the data correspond to the predetermined type of content; and
responsive to determining that the data correspond to the predetermined type of content, storing the source location of the data.

2. The method of claim 1, wherein determining a source location comprises determining a uniform resource locator (URL) of the source location of the data retrieved from the Internet based on packet information corresponding to the data.

3. The method of claim 1, wherein the predetermined type of content is video content.

4. The method of claim 1, further comprising:
determining whether the data correspond to a predetermined type of page; and
responsive to determining that the data correspond to the predetermined type of page, storing the source location of the data.

5. The method of claim 1, further comprising:
retrieving at least a portion of the content through the Internet; and
storing at least a part of the retrieved portion of the content as a graphical representation of the content.

6. The method of claim 5, further comprising:
displaying said part of the retrieved portion of the content in a user interface for bookmarking the content, together with the source location and information describing the content.

7. The method of claim 1, wherein determining whether the data correspond to the predetermined type of content comprises:
determining whether a portion of the received data is consistent with a predetermined file signature associated with the predetermined type of content.

8. A computer-implemented method of identifying a predetermined type of content, the method comprising:
determining, in a first computer, a source location of data retrieved from Internet;
responsive to determining that the data correspond to a predetermined type of page, storing the source location of the data in the first computer;
responsive to determining that the data correspond to the predetermined type of content, storing the source location of the data in the first computer; and
transmitting, to a second computer over the Internet, the source location of the data including a first URL of the data corresponding to the predetermined type of content and a second URL of the data corresponding to the predetermined type of page.

9. The method of claim 8, wherein the predetermined type of content is video content.

10. The method of claim 8, wherein determining a source location comprises determining the first URL and the second URL based on packet information corresponding to the data.

11. The method of claim 8, wherein the second computer retrieves at least a portion of the content through the Internet by accessing the first URL and stores at least a part of said retrieved portion of the content as a graphical representation of the content.

12. The method of claim 11, wherein the second computer does not retrieve said portion of the content if the first URL is one of a predetermined plurality of URLs associated with copyright restrictions.

13. The method of claim 1 1, wherein the predetermined type of content is video content and the second computer selects a frame of the retrieved portion of the video content with largest file size as the graphical representation of the content.

14. The method of claim 8, further comprising:
receiving in the first computer from the second computer an identification associated with said part of the retrieved portion of the content,
said identification being stored in the first computer.

15. The method of claim 14, further comprising:
transmitting to the second computer the identification stored in the first computer, wherein the second computer receives the transmitted identification and causes said part of the retrieved portion of the content together with the first URL to be displayed in a user interface on the first computer.

16. The method of claim 8, wherein determining whether the data correspond to the predetermined type of content comprises:
determining whether a portion of the received data is consistent with a predetermined file signature associated with the predetermined type of content.

17. The method of claim 8, further comprising:
retrieving in the first computer at least a portion of the content through the Internet and sending at least a part of said retrieved portion of the content to the second computer as a graphical representation of the content.

18. A computer program product stored on a computer readable medium and including computer instructions adapted to perform a computer-implemented method of identifying a predetermined type of content, the method comprising:
determining a source location of data retrieved from the Internet;
determining whether the data correspond to the predetermined type of content; and
responsive to determining that the data correspond to the predetermined type of content, storing the source location of the data.

19. The computer program product of claim 18, wherein determining a source location comprises determining a uniform resource locator (URL) of the source location of the data retrieved from the Internet based on packet information corresponding to the data.

20. The computer program product of claim 18, wherein the predetermined type of content is video content.

21. The computer program product of claim 18, wherein the method further comprises:
determining whether the data correspond to a predetermined type of page; and
responsive to determining that the data correspond to the predetermined type of page, storing the source location of the data.

22. The computer program product of claim 18, wherein the method further comprises:
retrieving at least a portion of the content through the Internet; and
storing at least a part of the retrieved portion of the content as a graphical representation of the content.

23. The computer program product of claim 22, wherein the method further comprises:
displaying said part of the retrieved portion of the content in a user interface for bookmarking the content, together with the source location and information describing the content.

24. The computer program product of claim 18, wherein determining whether the data correspond to the predetermined type of content comprises:
determining whether a portion of the received data is consistent with a predetermined file signature associated with the predetermined type of content.

25. A computer program product stored on a computer readable medium and including computer instructions adapted to perform a computer-implemented method of identifying a predetermined type of content, the method comprising:
determining, in a first computer, a source location of data retrieved from Internet;
responsive to determining that the data correspond to a predetermined type of page, storing the source location of the data in the first computer;
responsive to determining that the data correspond to the predetermined type of content, storing the source location of the data in the first computer; and
transmitting, to a second computer over the Internet, the source location of the data including a first URL of the data corresponding to the predetermined type of content and a second URL of the data corresponding to the predetermined type of page.

26. The computer program product of claim 25, wherein the predetermined type of content is video content.

27. The computer program product of claim 25, wherein determining a source location comprises determining the first URL and the second URL based on packet information corresponding to the data.

28. The computer program product of claim 25, wherein the second computer retrieves at least a portion of the content through the Internet by accessing the first URL and stores at least a part of said retrieved portion of the content as a graphical representation of the content.

29. The computer program product of claim 28, wherein the second computer does not retrieve said portion of the content if the first URL is one of a predetermined plurality of URLs associated with copyright restrictions.

30. The computer program product of claim 25, wherein the predetermined type of content is video content and the second computer selects a frame of the retrieved portion of the video content with largest file size as the graphical representation of the content.

31. The computer program product of claim 25, wherein the method further comprises:
receiving in the first computer from the second computer an identification associated with said part of the retrieved portion of the content,
said identification being stored in the first computer.

32. The computer program product of claim 31, wherein the method further comprises:
transmitting to the second computer the identification stored in the first computer, wherein the second computer receives the transmitted identification and causes said part of the retrieved portion of the content together with the first URL to be displayed in a user interface on the first computer.

33. The computer program product of claim 25, wherein determining whether the data correspond to the predetermined type of content comprises:
determining whether a portion of the received data is consistent with a predetermined file signature associated with the predetermined type of content.

34. The computer program product of claim 25, wherein the method further comprises:
retrieving in the first computer at least a portion of the content through the Internet and sending at least a part of said retrieved portion of the content to the second computer as a graphical representation of the content.

35. A computer apparatus including a storage device storing computer instructions adapted to perform a computer-implemented method of identifying a predetermined type of content and a processor for executing the computer instructions, the method comprising:
determining a source location of data retrieved from the Internet;
determining whether the data correspond to the predetermined type of content; and
responsive to determining that the data correspond to the predetermined type of content, storing the source location of the data.

36. The computer apparatus of claim 35, wherein determining a source location comprises determining a uniform resource locator (URL) of the source location of the data retrieved from the Internet based on packet information corresponding to the data.

37. The computer apparatus of claim 35, wherein the predetermined type of content is video content.

38. The computer apparatus of claim 37, wherein the method further comprises:
determining whether the data correspond to a predetermined type of page; and
responsive to determining that the data correspond to the predetermined type of page, storing the source location of the data.

39. The computer apparatus of claim 35, wherein the method further comprises:
retrieving at least a portion of the content through the Internet; and
storing at least a part of the retrieved portion of the content as a graphical representation of the content.

40. The computer apparatus of claim 39, wherein the method further comprises:
displaying said part of the retrieved portion of the content in a user interface for bookmarking the content, together with the source location and information describing the content.

41. The computer apparatus of claim 35, wherein determining whether the data correspond to the predetermined type of content comprises:
determining whether a portion of the received data is consistent with a predetermined file signature associated with the predetermined type of content.

42. A first computer including a storage device storing computer instructions adapted to perform a computer-implemented method of identifying a predetermined type of content and a processor for executing the computer instructions, the method comprising:
determining, in the first computer, a source location of data retrieved from Internet;
responsive to determining that the data correspond to a predetermined type of page, storing the source location of the data in the first computer;
responsive to determining that the data correspond to the predetermined type of content, storing the source location of the data in the first computer; and
transmitting, to a second computer over the Internet, the source location of the data including a first URL of the data corresponding to the predetermined type of content and a second URL of the data corresponding to the predetermined type of page.

43. The first computer of claim 42, wherein the predetermined type of content is video content.

44. The first computer of claim 42, wherein determining a source location comprises determining the first URL and the second URL based on packet information corresponding to the data.

45. The first computer of claim 42, wherein the second computer retrieves at least a portion of the content through the Internet by accessing the first URL and stores at least a part of said retrieved portion of the content as a graphical representation of the content.

46. The first computer of claim 42, wherein the second computer does not retrieve said portion of the content if the first URL is one of a predetermined plurality of URLs associated with copyright restrictions.

47. The first computer of claim 42, wherein the predetermined type of content is video content and the second computer selects a frame of the retrieved portion of the video content with largest file size as the graphical representation of the content.

48. The first computer of claim 42, wherein the method further comprises:
receiving in the first computer from the second computer an identification associated with said part of the retrieved portion of the content,
said identification being stored in the first computer.

49. The first computer of claim 48, wherein the method further comprises:
transmitting to the second computer the identification stored in the first computer, wherein the second computer receives the transmitted identification and causes said part of the retrieved portion of the content together with the first URL to be displayed in a user interface on the first computer.

50. The first computer of claim 42, wherein determining whether the data correspond to the predetermined type of content comprises:
determining whether a portion of the received data is consistent with a predetermined file signature associated with the predetermined type of content.

51. The first computer of claim 42, wherein the method further comprises:
retrieving in the first computer at least a portion of the content through the Internet and sending at least a part of said retrieved portion of the content to the second computer as a graphical representation of the content.
